(19) United States
(12) Patent Application Publication
(10) Pub. No.: US 2026/0353467 A1
(43) Pub. Date: Nov. 5, 2026

(54) TWO-PORT TRANSMISSIONS DURING INITIAL ACCESS

(71) Applicant: QUALCOMM Incorporated, San Diego, CA (US)

(72) Inventors: Xiaoxia ZHANG, San Diego, CA (US); Tao LUO, San Diego, CA (US); Junyi LI, Greentown, PA (US); Navid ABEDINI, Basking Ridge, NJ (US); Jianghong LUO, Skillman, NJ (US)

(21) Appl. No.: 19/199,160

(22) Filed: May 5, 2025

(51) Int. Cl. H04W 74/0833; H04W 52/02; H04W 56/00

(52) U.S. Cl. CPC H04W 74/0833; H04W 52/0235; H04W 56/0045

(57) ABSTRACT

This disclosure provides methods, components, devices and systems for multi-port transmissions during initial access. In some cases, a user equipment (UE) may transmit or receive one or more signals that enable multi-port random access channel (RACH) transmissions and, thus, may transmit a RACH message via multiple ports of the UE based on multi-port RACH transmissions being enabled. For example, the UE may transmit, via a first port of the multiple ports, a first portion of the RACH message indicative of a first subset of sequences and may transmit, via a second port of the multiple ports, a second portion of the RACH message indicative of a second subset of sequences. In such cases, each of the first subset of sequences and the second subset of sequences may include multiple repetitions of a same sequence.

### TECHNICAL FIELD

This disclosure relates generally to wireless communication, and more specifically to systems, devices, methods, and techniques associated with multi-port transmissions during initial access.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a user equipment (UE) is described. The method may include communicating, with a network entity, one or more signals that enable multi-port random access channel (RACH) transmissions and transmitting, to the network entity, a RACH message via a set of multiple ports of the UE based on multi-port RACH transmissions being enabled, where the RACH message indicates a set of multiple sequences, and where transmitting the RACH message includes transmitting, via a first port of the set of multiple ports of the UE, a first portion of the RACH message indicative of a first subset of the set of multiple sequences and transmitting, via a second port of the set of multiple ports, a second portion of the RACH message indicative of a second subset of the set of multiple sequences, where the first port is different from the second port.

A UE for wireless communications is described. The UE may include a processing system that includes processor circuitry and memory circuitry that stores code. The processing system may be configured to cause the UE to communicate, with a network entity, one or more signals that enable multi-port RACH transmissions and transmit, to the network entity, a RACH message via a set of multiple ports of the UE based on multi-port RACH transmissions being enabled, where the RACH message indicates a set of multiple sequences, and where, to transmit the RACH message, the processing system is further configured to cause the UE to transmit, via a first port of the set of multiple ports of the UE, a first portion of the RACH message indicative of a first subset of the set of multiple sequences and transmit, via a second port of the set of multiple ports, a second portion of the RACH message indicative of a second subset of the set of multiple sequences, where the first port is different from the second port.

Another UE for wireless communications is described. The UE may include means for communicating, with a network entity, one or more signals that enable multi-port RACH transmissions and means for transmitting, to the network entity, a RACH message via a set of multiple ports of the UE based on multi-port RACH transmissions being enabled, where the RACH message indicates a set of multiple sequences, and where the means for transmitting the RACH message include means for transmitting, via a first port of the set of multiple ports of the UE, a first portion of the RACH message indicative of a first subset of the set of multiple sequences and means for transmitting, via a second port of the set of multiple ports, a second portion of the RACH message indicative of a second subset of the set of multiple sequences, where the first port is different from the second port.

A non-transitory computer-readable medium storing code for wireless communications is described. The code may include instructions executable by one or more processors to communicate, with a network entity, one or more signals that enable multi-port RACH transmissions and transmit, to the network entity, a RACH message via a set of multiple ports of the UE based on multi-port RACH transmissions being enabled, where the RACH message indicates a set of multiple sequences, and where the instructions to transmit the RACH message are executable to transmit, via a first port of the set of multiple ports of the UE, a first portion of the RACH message indicative of a first subset of the set of multiple sequences and transmit, via a second port of the set of multiple ports, a second portion of the RACH message indicative of a second subset of the set of multiple sequences, where the first port is different from the second port.

In some examples of the method, UEs, and non-transitory computer-readable medium described herein, the first subset of the set of multiple sequences and the second subset of the set of multiple sequences each include a set of multiple repetitions of a first sequence.

In some examples of the method, UEs, and non-transitory computer-readable medium described herein, the RACH message may be transmitted in accordance with a timing advance compensation based on the first portion of the RACH message and the second portion of the RACH message being transmitted during a same RACH occasion (RO).

In some examples of the method, UEs, and non-transitory computer-readable medium described herein, transmitting the RACH message via the set of multiple ports may include operations, features, means, or instructions for transmitting the first portion of the RACH message during a first single-port RO of the set of multiple single-port ROs and transmitting the second portion of the RACH message during a second single-port RO of the set of multiple single-port ROs.

In some examples of the method, UEs, and non-transitory computer-readable medium described herein, transmitting the RACH message via the set of multiple ports may include operations, features, means, or instructions for transmitting the first portion of the RACH message during a first portion of the RO and transmitting the second portion of the RACH message during a second portion of the RO, where the second portion of the RACH message includes a cyclic prefix subsequent to an end of the first portion of the RACH message based on the first portion of the RACH message and the second portion of the RACH message being transmitted during a same RO.

In some examples of the method, UEs, and non-transitory computer-readable medium described herein, communicating the one or more signals that enables the multi-port RACH transmissions may include operations, features, means, or instructions for receiving a multi-port downlink signal, where enablement of the multi-port RACH transmissions may be based on measurement of the multi-port downlink signal.

In some examples of the method, UEs, and non-transitory computer-readable medium described herein, communicating the one or more signals that enables the multi-port RACH transmissions may include operations, features, means, or instructions for receiving one or more control messages indicative of configuration information for multi-port RACH transmissions, where enablement of the multi-port RACH transmissions may be in response to reception of the one or more control messages.

In some examples of the method, UEs, and non-transitory computer-readable medium described herein, communicating the one or more signals that enables the multi-port RACH transmissions may include operations, features, means, or instructions for transmitting an uplink wake-up signal (WUS) indicative of a request to enable multi-port RACH transmissions, where enablement of the multi-port RACH transmissions may be in response to transmission of the uplink WUS.

Some examples of the method, UEs, and non-transitory computer-readable medium described herein may further include operations, features, means, or instructions for receiving one or more control messages indicative of a set of multiple RO formats, where communicating the one or more signals that enable the multi-port RACH transmissions includes receiving a second control message indicative of a first RO format of the set of multiple RO formats, where enablement of the multi-port RACH transmissions may be based on the first RO format supporting multi-port RACH transmissions.

In some examples of the method, UEs, and non-transitory computer-readable medium described herein, the RACH message includes one or more demodulation reference signals (DMRSs) and the method, apparatuses, and non-transitory computer-readable medium may include further operations, features, means, or instructions for transmitting, via a third port of the set of multiple ports, one or more other reference signals based on the multi-port RACH transmissions being enabled.

A method for wireless communications by a network entity is described. The method may include communicating, with a UE, one or more signals that enable multi-port RACH transmissions and receiving, from the UE, a RACH message based on multi-port RACH transmissions being enabled, wherein the RACH message indicates a set of multiple sequences, and where receiving the RACH message includes receiving a first portion of the RACH message indicative of a first subset of set of multiple sequences and receiving a second portion of the RACH message indicative of a second subset of set of multiple sequences.

A network entity for wireless communications is described. The network entity may include a processing system that includes processor circuitry and memory circuitry that stores code. The processing system may be configured to cause the network entity to communicate, with a UE, one or more signals that enable multi-port RACH transmissions and receive, from the UE, a RACH message based on multi-port RACH transmissions being enabled, wherein the RACH message indicates a set of multiple sequences, and where, to receive the RACH message, the processing system is further configured to cause the network entity to receive a first portion of the RACH message indicative of a first subset of set of multiple sequences and receive a second portion of the RACH message indicative of a second subset of set of multiple sequences.

Another network entity for wireless communications is described. The network entity may include means for communicating, with a UE, one or more signals that enable multi-port RACH transmissions and means for receiving, from the UE, a RACH message based on multi-port RACH transmissions being enabled, wherein the RACH message indicates a set of multiple sequences, and where the means for receiving the RACH message include means for receiving a first portion of the RACH message indicative of a first subset of set of multiple sequences and means for receiving a second portion of the RACH message indicative of a second subset of set of multiple sequences.

A non-transitory computer-readable medium storing code for wireless communications is described. The code may include instructions executable by one or more processors to communicate, with a UE, one or more signals that enable multi-port RACH transmissions and receive, from the UE, a RACH message based on multi-port RACH transmissions being enabled, wherein the RACH message indicates a set of multiple sequences, and where the instructions to receive the RACH message are executable to receive a first portion of the RACH message indicative of a first subset of set of multiple sequences and receive a second portion of the RACH message indicative of a second subset of set of multiple sequences.

In some examples of the method, network entities, and non-transitory computer-readable medium described herein, the first subset of set of multiple sequences and the second subset of set of multiple sequences each include a set of multiple repetitions of a first sequence.

In some examples of the method, network entities, and non-transitory computer-readable medium described herein, the RACH message may be received in accordance with a timing advance compensation based on the first portion of the RACH message and the second portion of the RACH message being received during a same RO.

In some examples of the method, network entities, and non-transitory computer-readable medium described herein, receiving the RACH message may include operations, features, means, or instructions for receiving the first portion of the RACH message during a first single-port RO of the set of multiple single-port ROs and receiving the second portion of the RACH message during a second single-port RO of the set of multiple single-port ROs.

In some examples of the method, network entities, and non-transitory computer-readable medium described herein, receiving the RACH message may include operations, features, means, or instructions for receiving the first portion of the RACH message during a first portion of the RO and receiving the second portion of the RACH message during a second portion of the RO, where the second portion of the RACH message includes a cyclic prefix subsequent to an end of the first portion of the RACH message based on the first portion of the RACH message and the second portion of the RACH message being transmitted during a same RO.

In some examples of the method, network entities, and non-transitory computer-readable medium described herein, communicating the one or more signals that enables the multi-port RACH transmissions may include operations, features, means, or instructions for transmitting a multi-port downlink signal, where enablement of the multi-port RACH transmissions may be based on the multi-port downlink signal.

In some examples of the method, network entities, and non-transitory computer-readable medium described herein, communicating the one or more signals that enables the multi-port RACH transmissions may include operations, features, means, or instructions for transmitting one or more control messages indicative of configuration information for multi-port RACH transmissions, where enablement of the multi-port RACH transmissions may be in response to transmission of the one or more control messages.

In some examples of the method, network entities, and non-transitory computer-readable medium described herein, communicating the one or more signals that enables the multi-port RACH transmissions may include operations, features, means, or instructions for receiving an uplink WUS indicative of a request to enable multi-port RACH transmissions, where enablement of the multi-port RACH transmissions may be in response to transmission of the uplink WUS.

Some examples of the method, network entities, and non-transitory computer-readable medium described herein may further include operations, features, means, or instructions for transmitting one or more control messages indicative of a set of multiple RO formats, where communicating the one or more signals that enable the multi-port RACH transmissions includes transmitting a second control message indicative of a first RO format of the set of multiple RO formats, where enablement of the multi-port RACH transmissions may be based on the first RO format supporting multi-port RACH transmissions.

In some examples of the method, network entities, and non-transitory computer-readable medium described herein, the RACH message includes one or more DMRSs and the method, apparatuses, and non-transitory computer-readable medium may include further operations, features, means, or instructions for receiving one or more other reference signals based on the multi-port RACH transmissions being enabled.

### BRIEF DESCRIPTION OF THE DRAWINGS

FIG. 1 shows an example of a wireless communication system.

FIG. 2 shows an example of a signaling diagram that supports multi-port transmissions during initial access.

FIG. 3 shows examples of random access channel (RACH) occasion (RO) configurations that supports multi-port transmissions during initial access.

FIG. 4 shows examples of RO formats that supports multi-port transmissions during initial access.

FIG. 5 shows examples of resource diagrams that supports multi-port transmissions during initial access.

FIG. 6 shows an example of a process flow that supports multi-port transmissions during initial access.

FIG. 7 shows a block diagram of a processing system that supports multi-port transmissions during initial access.

FIG. 8 shows a diagram of a system including a device that supports multi-port transmissions during initial access.

FIG. 9 shows a block diagram of a processing system that supports multi-port transmissions during initial access.

FIG. 10 shows a diagram of a system including a device that supports multi-port transmissions during initial access.

FIGS. 11 and 12 show flowcharts illustrating methods that support multi-port transmissions during initial access.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

Some wireless communications systems may support random access channel (RACH) procedures to establish a connection between a user equipment (UE) and a network entity. In such cases, during a RACH procedure, a UE may attempt to collect channel state information (CSI) for use by the UE during the RACH procedure (e.g., to enable high data rates). However, resources available for collection of CSI during the RACH procedure may be limited (e.g., as compared to resources available prior to or after connection establishment), and the limited resources may limit an ability of the UE to collect the CSI, which may result in increased latency of completing the connection establishment.

Aspects of the subject matter described in this disclosure relate to multi-port RACH transmission to enable a higher data rate (e.g., than single-port RACH transmissions) and a reduced latency of connection establishment. For example, a UE may determine that multi-port RACH transmissions are enabled (e.g., based on transmission or reception of one or more signals) and may transmit a first portion of a RACH message via a first port (e.g., of multiple ports of the UE) and may transmit a second portion of the RACH message via a second port (e.g., of the multiple ports) based on multi-port RACH transmissions being enabled. In such cases, each portion of the RACH message may include multiple repetitions of a same sequence.

In some cases, the UE may transmit the first portion of the RACH message and the second portion of the RACH message via one RACH occasion (RO). In such cases, the first portion of the RACH message may start with a cyclic prefix (CP) and the second portion of the RACH message may end with guard time (GT) (e.g., a guard interval).

In some other cases, the UE may transmit the first portion of the RACH message and the second portion of the RACH message via a multi-port RO (e.g., super RO) that includes multiple single-port ROs, where the UE transmits the first portion of the RACH message via a first single-port RO of the multi-port RO and transmits the second portion of the RACH message via a second single-port RO of the multi-port RO. In some examples, the first single-port RO and the second single-port RO may be separated by a duration, such that each portion of the RACH message starts with a respective CP and ends with respective GT. In some other examples, the first single-port RO and the second single-port RO may be back-to-back, such that the first portion of the RACH message starts with a first CP (e.g., and does not include GT) and the second portion of the RACH message starts with a second CP and ends with GT.

In some other cases, the first portion of the RACH message and the second portion of the RACH message may be transmitted via multiple multi-port ROs, where each multi-port RO corresponds to a respective port of the multiple ports. For example, the UE may transmit the first portion of the RACH message via a first multi-port RO and may transmit the second portion of the RACH message via a second multi-port RO. In such cases, the first portion of the RACH message may start with a first CP (e.g., and does not include GT) and the second portion of the RACH message may start with a second CP and end with GT.

Additionally, or alternatively, the UE may support multiple RO formats (e.g., multiple types of RO formats). For example, a first RO format may be associated with single-port RACH transmissions and a first duration, a second RO format may be associated with multi-port RACH transmissions (e.g., or single-port RACH transmissions by multiple UEs), and a third RO format may be associated with single-port RACH transmissions and a second duration, longer than the first duration. Thus, the network entity may indicate for one or more ROs, which RO format is to be used by the UE for transmission of a respective RACH message.

Particular aspects of the subject matter described in this disclosure can be implemented to realize one or more of the following potential advantages. In some examples, by transmitting a RACH message via multiple ports, the described techniques may be used to increase a data rate of communication (e.g., as compared to single-port RACH transmissions) which may further result in decreased latency of connection establishment. Additionally, or alternatively, by support multiple RO formats, the described techniques may enable the network entity to select a RO format based on one or more conditions associated with the UE (e.g., high geometry vs low geometry), which may result in increased communication efficiency and decreased power consumption.

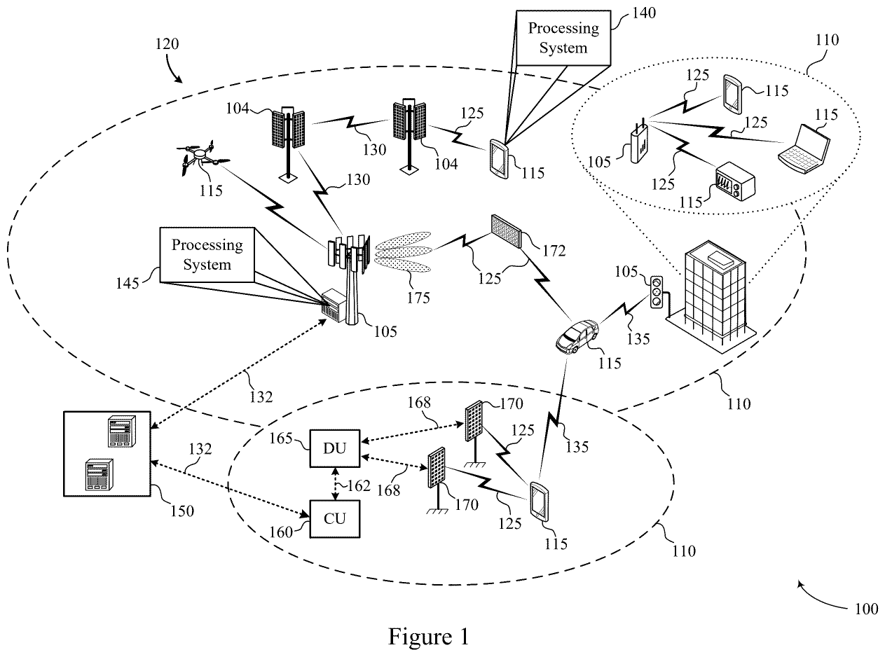

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, DMRSs (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Some wireless communications systems, such as the wireless communications system 100, may support single port transmissions (e.g., signals) for broadcast channels (e.g., signals). For example, a network entity 105 may transmit a single-port synchronization signal block (SSB), a single-port physical broadcast channel (PBCH), a single-port physical downlink control channel (PDCCH), a single-port physical downlink shared channel (PDSCH), or any combination thereof, for a broadcast channel (e.g., remaining minimum system information (RMSI), system information block (SIB), paging, etc.).

Additionally, or alternatively, the wireless communications system 100, may support multi-port synchronization signal block (SSB) communications (e.g., two-port SSB). For example, a network entity 105 may transmit, via a first port, an SSB (e.g., including a primary synchronization signal (PSS), a secondary synchronization signal (SSS), and a physical broadcast channel (PBCH)) and, via a second port, another reference signal. In such cases, a UE 115 may use both of the SSB transmitted via the first port and the other reference signal transmitted via the second port for SSB selection. The multi-port signal (e.g., SSB and other reference signal) may enable the UE to evaluate a channel corresponding to the SSB in accordance with both rank and signal strength (e.g., rather than just signal strength). For example, the UE 115 may select an SSB with a lower signal strength but with a higher rank (e.g., and a higher capacity).

Devices of the wireless communication system 100 may be configured to support one or more aspects of the described techniques for multi-port transmissions during initial access. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support multi-port RACH transmissions, which may result in an increased data rate of communication (e.g., as compared to single-port RACH transmissions), which may further result in decreased latency of connection establishment. Additionally, or alternatively, by configuring the processing system 140, the processing system 145, or the combination thereof in accordance with the described techniques, the communication system 100 may enable a network entity to select an RO format based on one or more conditions associated with the UE 115 (e.g., high geometry vs low geometry), which may result in increased communication efficiency and decreased power consumption.

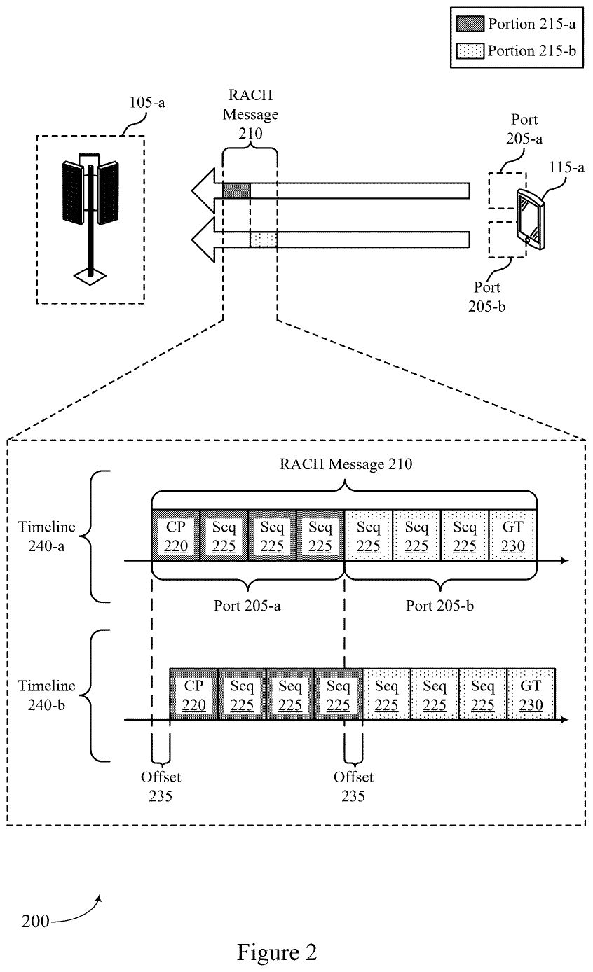

FIG. 2 shows an example of a signaling diagram 200 that supports multi-port transmissions during initial access. The signaling diagram 200 may implement or be implemented by aspects of the wireless communication system 100. For example, the signaling diagram 200 may include one or more UEs 115 (e.g., a UE 115-a), one or more network entities 105 (e.g., a network entity 105-a), or both, which may be examples of the corresponding devices described herein, including with reference to FIG. 1.

Some wireless communications systems may support random access channel (RACH) procedures to establish a connection between a UE 115, such as the UE 115-a, and a network entity 105, such as the network entity 105-a. In such cases, during a RACH procedure, a UE may attempt to generate (e.g., collect, acquire, measure) channel state information (CSI) for use by the UE 115-a during the RACH procedure (e.g., to enable high data rates, or speed up data delivery, to reduce overall latency). To generate the CSI, the UE 115-a may measure one or more reference signals. However, resources available for measurement of the one or more reference signals during the RACH procedure may be limited (e.g., as compared to resources available prior to or after connection establishment). Thus, the UE 115-a may be limited in an ability of the UE 115-a to generate the CSI, thus resulting in increased latency of completing the connection establishment.

Accordingly, techniques described herein may support multi-port (e.g., two-port) RACH transmissions in initial access (e.g., multi-port transmissions for RACH or Msg1 of a RACH procedure, multi-port transmissions for a signal/channel used for the RACH procedure), which may result in a faster data rate delivery (e.g., as compared to single-port RACH transmissions). For example, the network entity 105-a may use a multi-port RACH transmission for channel sounding and to determine a downlink transmission (e.g., a more than one layer transmission). In TDD, the network entity 105-a may use the multi-port RACH transmission, as well as a reciprocity assumption, to derive a downlink layer, a downlink rank, a downlink channel, or any combination thereof. In FDD, the network entity 105-a may use the multi-port RACH transmission, as well as prediction-based processing, to predict the downlink layer, the downlink rank, the downlink channel, or any combination thereof. Additionally, or alternatively, multi-port RACH transmissions may support a joint uplink and downlink operation (e.g., sounding a multi-port channel in uplink and downlink).

For example, in some cases, within a same RO, the UE 115-a may use different ports 205 (e.g., transmit (Tx) ports 205) to transmit different subsets of sequences 225 (e.g., RACH sequences). For example, the UE 115-a may support multiple ports 205, including at least a port 205-a and a port 205-b. Thus, when multi-port RACH transmissions are enabled, rather than transmitting a RACH message 210 (e.g., including a CP 220, multiple repetitions of a sequence 225, and a GT 230) via a single port 205 (e.g., according to a legacy RACH transmission format with single port), the UE 115-a may transmit a portion 215-a of the RACH message 210 (e.g., physical RACH (PRACH) message) via the port 205-a and may transmit a portion 215-bof the RACH message 210 via the port 205-b. In such cases, the portion 215-a of the RACH message 210 may include the CP 220 and a first subset of sequences 225 and the portion 215-bof the RACH message 210 may include a second subset of sequences 225 and the GT 230 (e.g., a guard interval, a guard symbol). In some cases, each of the first subset of sequences 225 and the second subset of sequences 225 may include a respective quantity of repetitions of a same sequence 225. For example, the first subset of sequences 225 may include three repetitions of the sequence 225 and the second subset of sequences 225 may similarly, include three repetitions of the same sequence 225. In some other cases, the first subset of sequences 225 may include a quantity of repetitions of a first sequence 225 and the second subset of sequences 225 may include a quantity of repetitions of a second sequence 225, where the first sequence 225 is different from the second sequence 225.

In such cases, the network entity 105-a may configure the UE 115 with the multiple ports 205 to be used by the UE 115-a (e.g., configure the UE 115-a to use the port 205-a and the port 205-b), with a corresponding subset of sequences 225 to be transmitted via each port 205 (e.g., configure the UE 115-a with a respective quantity or repetitions of the same sequence 225 to be included in each subset of sequences 225), or both. For example, the network entity 105-a may transmit configuration information indicating for the UE 115-a to transmit three repetitions of the sequence 225 (e.g., the first subset of sequences 225) via the port 205-a and to transmit three repetitions of the sequence 225 (e.g., the second subset of sequences 225) via the port 205-b.

In some cases, due to uncertainty of a round trip time (RTT) between the network entity 105-a and the UE 115-a, the network entity 105-a may not be aware of when the UE 115-a switches ports 205 (e.g., from the port 205-a to the port 205-b) from a receiver timing perspective. That is, the UE 115-a may transmit the RACH message 210 according to a timeline 240-a but the network entity 105-a may receive the RACH message 210 according to a timeline 240-b, where reception of the RACH message 210 by the network entity 105-a occurs at an offset 235 from transmission of the RACH message 210 by the UE 115-a. When the UE 115-a switches ports, the network entity 105-a may detect a change in a channel used to receive the RACH message 210, such that when reception of the RACH message 210 by the network entity 105-a occurs at the offset 235 from transmission of the RACH message 210 by the UE 115-a, the network entity 105-a may detect the channel change within a sequence correlation duration (e.g., Fast Fourier Transform (FFT) duration), which may result in interference to detection of other RACH preambles. Additionally, if a timing advance (TA) is large (e.g., greater than a threshold), the effect of the interference may be more severe (e.g., as compared to a TA less than the threshold).

Accordingly, to mitigate the channel change effect, the network entity 105-a may indicate for the UE 115-a to transmit the RACH message 210 with a-priori TA compensation. For example, the UE 115-a may obtain a TA based on a location of the UE (e.g., a Fixed Wireless Access (FWA) deployment), may obtain the TA from another UE 115 located within a threshold proximity of the UE 115-a, or both, and may transmit the RACH message 210 in accordance with the obtained TA. Transmitting the RACH message in accordance with the obtained TA may enable the UE 115-a to reduce a TA between the network entity 105-a and the UE 115-a to within a threshold range to reduce impacts of the channel change effect when the UE 115-a switches from the port 205-a to the port 205-b. In some cases, the UE 115-a may transmit the multi-port RACH message 210 (e.g., with different subsets of sequences 225) based on (e.g., only if) the UE 115-a obtaining a-priori TA knowledge. Additionally, or alternatively, the network entity 105-a may use separate ROs for multi-port RACH transmissions compared to single-port RACH transmissions instead of using preamble partitioning within a same RO between single-port RACH transmissions and multi-port RACH transmissions.

Though described in the context of the port 205-a and the port 205-b, this is not to be regarded as a limitation of the present disclosure. In this regard, any quantity of ports 205 may be considered with regards to the techniques described herein.

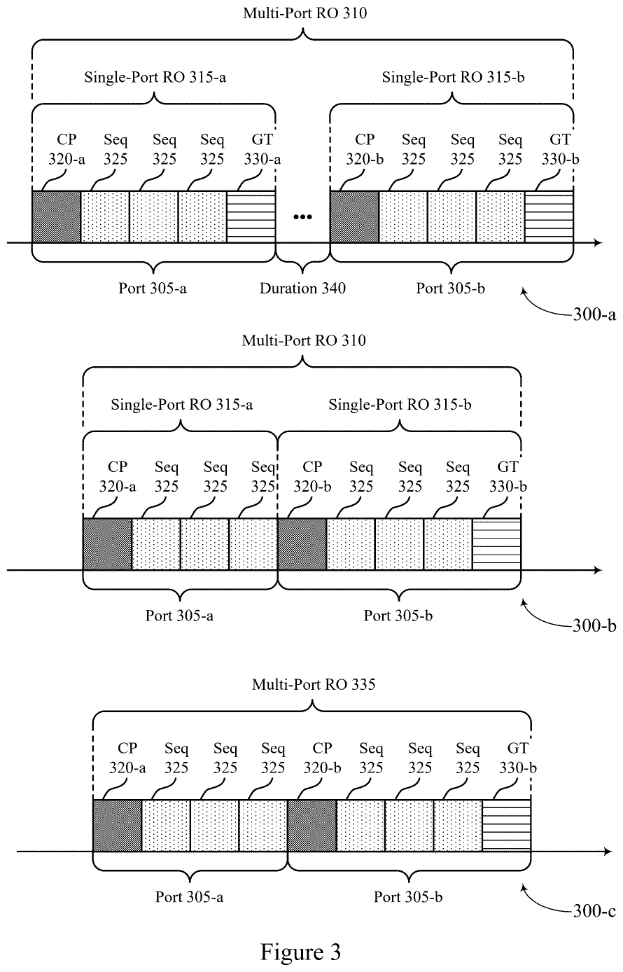

FIG. 3 shows examples of RO configurations 300 (e.g., an RO configuration 300-a, an RO configuration 300-b, and an RO configuration 300-c) that support multi-port transmissions during initial access. The RO configurations 300 may implement or be implemented by aspects of the wireless communication system 100, the signaling diagram 200, or both. For example, the RO configurations 300 may be implemented by one or more UEs 115, one or more network entities 105, or both, which may be examples of the corresponding devices described herein, including with reference to FIG. 1.

As described herein, when multi-port RACH transmissions are enabled, a UE 115 may transmit a first portion of a RACH message via a port 305-a and a second portion of the RACH message via a port 305-b. In some examples, as described with reference to the RO configuration 300-a and the RO configuration 300-b, the UE 115 may transmit the RACH message during a multi-port RO 310 (e.g., super RO) that includes multiple single-port ROs 315 (e.g., with smaller sequence repetition as compared to a legacy single-port RO), where each single-port RO 315 corresponds to a different port 305. For example, the multi-port RO 310 may include a single-port RO 315-a corresponding to the port 305-a and a single-port RO 315-b corresponding to the port 305-b. Thus, the UE 115 may transmit the first portion of the RACH message via the port 305-a during the single-port RO 315-a and may transmit the second portion of the RACH message via the port 305-b during the single-port RO 315-b. In such cases, to maintain a similar overhead as the legacy single-port RO associated with the legacy RACH transmission format (e.g., including a CP 320, six repetitions of the sequence 325, and a GT 330 transmitted via a single port 305), as described with reference to FIG. 2, the multi-port RO 310 may include a same quantity of sequences 225 as the legacy single-port RO (e.g., six sequences 225 across both ports 305). That is, the legacy single-port RO may include a first quantity of repetitions of the sequence 225, such that each of the single-port ROs 315 may include half the first quantity of repetitions of the sequence 225.

In some examples, as described with reference to the RO configuration 300-a, the single-port ROs 315 may be separated by a duration 340 (e.g., may not be back-to-back). That is, the single-port RO 315-a may end and the single-port RO 315-b may not start until after the duration 340 from the end of the single-port RO 315-a. In such cases, each portion of the RACH message may include a CP 320 and a GT 330. For example, the first portion of the RACH message may include a CP 320-a, three repetitions of the sequence 325, and a GT 330-a and the second portion of the RACH message may include a CP 320-b, three repetitions of the sequence 325, and a GT 330-b. Thus, compared to the legacy single-port RO, the additional overhead may include the CP 320-b and the GT 330-a.

In some other examples, as described with reference to the RO configuration 300-b, the single-port ROs 315 may be back-to-back (e.g., not separated by the duration 340). That is, the single-port RO 315-b may start after (e.g., immediately after) the single-port RO 315-a ends. In such cases, the first portion of the RACH message may include the CP 320-a and the three repetitions of the sequence 325 and the second portion of the RACH message may include the CP 320-b, the three repetitions of the sequence 325, and the GT 330-b. In other words, one GT 330 may be used for the last single-port RO 315-b (e.g., the later single-port RO 315-b can start at a start of the GT 330 in the previous single-port RO 315-a). Thus, compared to the legacy single-port RO, the additional overhead may include the CP 320-b.

In some other examples, as described with reference to the RO configuration 300-c, the UE 115 may transmit the RACH message during a multi-port RO 335 (e.g., that does not include multiple single-port ROs 315) with a CP insertion for the port change. That is, the multi-port RO 335 may include a CP 320-b after the UE 115 switches from the port 305-a to the port 305-b. For example, the UE 115 may transmit the first portion of the RACH message via the port 305-a (e.g., during a first portion of the multi-port RO 335) and, after the UE 115 switches from the port 305-a to the port 305-b, the UE 115 may begin transmission of the second portion of the RACH message (e.g., via the port 305-a) with the CP 320-b. Thus, the first portion of the RACH message may include the CP 320-a and the three repetitions of the sequence 325 and the second portion of the RACH message may include the CP 320-b, the three repetitions of the sequence 325, and the GT 330-b. Thus, compared to the legacy single-port RO, the additional overhead may include the CP 320-b.

In some cases, the network entity 105 may enable multi-port RACH transmissions for high geometry UEs 115 for fast data ramp up. A high geometry UE 115 may be a UE 115 associated with a reference signal receive power (RSRP) greater than or equal to a threshold RSRP (e.g., configured by the network entity 105), a signal to noise ratio (SNR) greater than or equal to a threshold SNR (e.g., configured by the network entity 105), a signal to interference and noise (SINR) greater than or equal to a threshold SINR (e.g., configured by the network entity 105), a received signal strength indicator (RSSI) greater than or equal to a threshold RSSI (e.g., configured by the network entity 105), or any combination thereof (e.g., a high RSRP/SNR/SINR/RSSI). Conversely, a low geometry UE 115 may be a UE 115 associated with an RSRP less than the threshold RSRP, an SNR less than the threshold SNR, an SINR less than the threshold SINR, an RSSI less than the threshold RSSI, or any combination thereof (e.g., low RSRP/SNR/SINR/RSSI). Thus, UEs 115 with RSRPs greater than or equal to the threshold RSRP may use multi-port ROs (e.g., a multi-port RO 310 and/or a multi-port RO 335).

Additionally, or alternatively, multi-port RACH transmissions may be enabled for the UE 115 based on multi-port downlink signaling. For example, when a multi-port downlink signal is transmitted by the network entity 105 (e.g., two-port SSB), the UE 115 may use a downlink channel (e.g., used to transmit the multi-port downlink signal) to determine whether to enable (e.g., allow) or disable (e.g., disallow) multi-port RACH transmissions. In some cases, if more than one layer can be supported based on downlink signal measurements, the UE 115 may enable multi-port RACH transmissions. In another example, for non-codebook-based transmissions for single or multi-port RACH transmissions, the UE 115 may use the multi-port downlink signal to determine uplink transmission precoding for single or multi-port RACH transmission. Additionally, or alternatively, the UE 115 may determine an interference estimation (e.g., interference covariance matrix, Rnn) and may apply an operation to uplink transmission based on the interference estimation. For example, the UE 115 may perform a noise whitening operation and a whitening matrix, used by the UE 115 to transmit a multi-port RACH message, may be based on the downlink multi-port signal.

Additionally, or alternatively, the network entity 105-a may indicate, to the UE 115, separate RACH configurations (e.g., PRACH configurations) for multi-port RACH transmissions and single-port RACH transmissions. In such cases, each RACH configuration may indicate one or more of a respective RO periodicity, RACH target power, power ramping up step size, or the like thereof. For example, the network entity 105-a may transmit, to the UE 115-a, configuration information indicating a first RACH configuration for multi-port RACH transmissions and a second RACH configuration for single-port RACH transmissions. In some cases, the first RACH configuration may indicate a first RO periodicity, a first RACH target power, a first power ramping up step size, or any combination thereof, and the second RACH configuration may indicate a second RO periodicity, a second RACH target power, a second power ramping up step size, or any combination thereof, where the first RO periodicity is the same as or different from the second RO periodicity, the first RACH target power is the same as or different from the second RACH target power, and the first power ramping up step size is the same as or different from the second power ramping up step size.

Additionally, or alternatively, the UE 115 may support on-demand multi-port RACH transmissions. For example, the UE 115 may transmit an uplink WUS indicating a request for single-port RACH transmissions or multi-port RACH transmissions. In some cases, the network entity 105-a may transmit one or more messages in response to the uplink WUS either accepting or rejecting the request by the UE 115. For example, the network entity 105 may determine whether to enable legacy RO adaptation (e.g., legacy single-port ROs), multi-port RO adaptation (e.g., multi-port ROs), or both. In such cases, the network entity 105 may control legacy RO adaptation and multi-port RO adaptation separately.

In some examples (e.g., non-codebook-based two virtual ports 305), multi-port RACH transmissions may be communicated to different remote radio heads (RRHs) associated with different TAs. In some cases, the UE 115 may transmit each portion of the RACH message via a respective port 305 with different timing. For example, the UE 115 may transmit the first portion of the RACH message via the port 305-a according to first timing (e.g., a first TA) and may transmit the second portion of the RACH message via the port 305-b according to second timing (e.g., a second TA). In some examples, each port 305 may be associated with (e.g., follow independently) respective downlink reception timing for transmission of a respective portion of the RACH message. In some other examples, the UE 115 may compensate for the timing different across RRHs (e.g., transmission reception points (TRPs)) when it transmits the multi-port RACH message. In some other cases, the UE 115 may transmit each portion of the RACH message via a respective port 305 in accordance with common uplink transmission timing (e.g., based on downlink reception timing associated with one of the RRHs).

In some cases, when different timing is used for different ports 305, the network entity 105 may indicate multiple TAs to the UE 115. For example, the network entity 105 may indicate the first TA for the port 305-a and the second TA for the port 305-b in a first downlink message of a RA procedure, such as a random access response (RAR) (e.g., msg2). In some cases, the RAR may include 12 bits for indication of a single TA, such that an additional TA may be indicated using fewer bits (e.g., less than 12 bits) and may be based on a delta relative to the single TA (e.g., a first reference TA). In some examples, the network entity 105 may advertise a quantity of bits for the additional TA in a system information block (SIB). Additionally, or alternatively, the network entity 105 may apply TA pre-compensation when the network entity 105 uses non-co-located RRHs downlink transmissions based on a TA derived from a multi-port RACH transmission. Additionally, or alternatively, with multi-port RACH transmissions, the network entity 105 may enable multi-layer transmissions for msg3 PUSCH of the RA procedure. In such cases, uplink precoding and layer information may be included in the RAR.

Though described in the context of the port 305-a and the port 305-b, this is not to be regarded as a limitation of the present disclosure. In this regard, any quantity of ports 305 may be considered with regards to the techniques described herein.

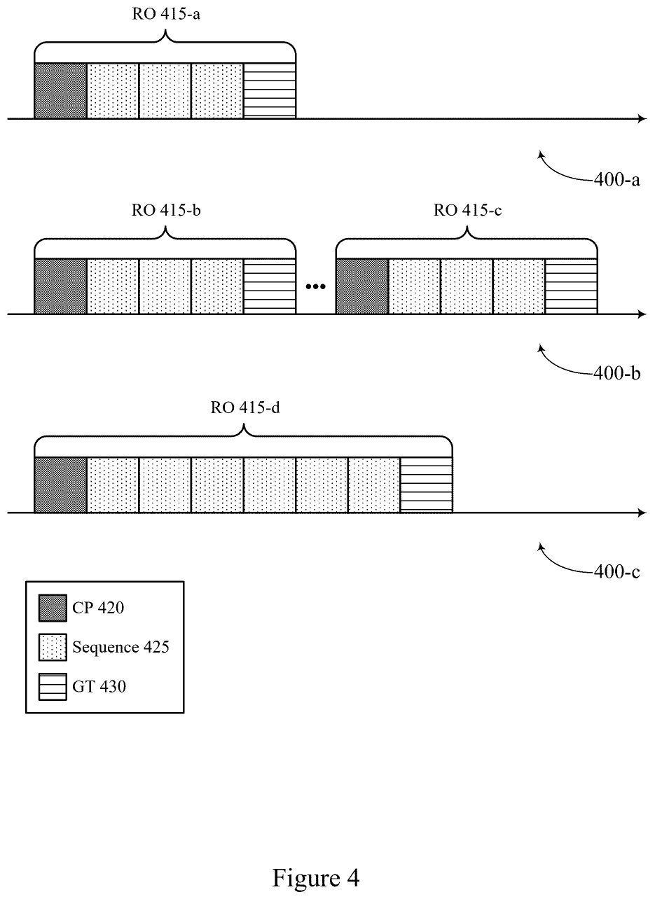

FIG. 4 shows examples of RO formats 400 (e.g., an RO format 400-a, an RO format 400-b, and an RO format 400-c) that support multi-port transmissions during initial access. The RO formats 400 may implement or be implemented by aspects of the wireless communication system 100, the signaling diagram 200, the RO configurations 300, or any combination thereof. For example, the RO formats 400 may be implemented by one or more UEs 115, one or more network entities 105, or both, which may be examples of the corresponding devices described herein, including with reference to FIG. 1.

In some examples, a UE 115 may support RACH transmissions with different RO formats 400 (e.g., PRACH formats). In other words, the UE 115 may support multiple RO formats 400 (e.g., independent of single-port or multi-port RACH). For example, the multiple RO formats 400 may include multiple single-port RO formats, such as an RO format 400-a and an RO format 400-c, where the RO format 400-a includes a smaller quantity of repetitions of a sequence 425 for high geometry UEs 115 (e.g., as described with reference to FIG. 3) and the RO format 400-c may include a larger quantity of repetitions of the sequence 425 for low geometry UEs 115. In other words, an RO 415-a of the RO format 400-a may be shorter than an RO 415-d of the RO format 400-c, but both the RO format 400-a and the RO format 400-c may be used for single-port RACH transmissions.

Additionally, or alternatively, the multiple RO formats 400 may include an RO format 400-b, where the RO format 400-b may support one high geometry UE to use two short ROs 415, such as an RO 415-b and an RO 415-c, for a two-port RACH transmission (e.g., as described with reference to FIG. 3) or may support two high geometry UEs 115 performing single-port RACH transmissions. For example, a first UE 115 may perform a first single-port RACH transmission during the RO 415-b and a second UE 115 may perform a second single-port RACH transmission during the RO 415-b. In some cases, a network entity 105 may indicate, to the UE 115, the multiple RO formats 400, a different RACH configuration for each RO format 400, or both. In some examples, each of the ROs 415 (e.g., regardless of RO format) may include any combination of a CP 420, a quantity of repetitions of the sequence 425, and a GT 430.

Though described in the context of two ports, this is not to be regarded as a limitation of the present disclosure. In this regard, any quantity of ports may be considered with regards to the techniques described herein, such that additional RO formats may be associated with other multi-port RACH transmission, such as three-port RACH transmissions.

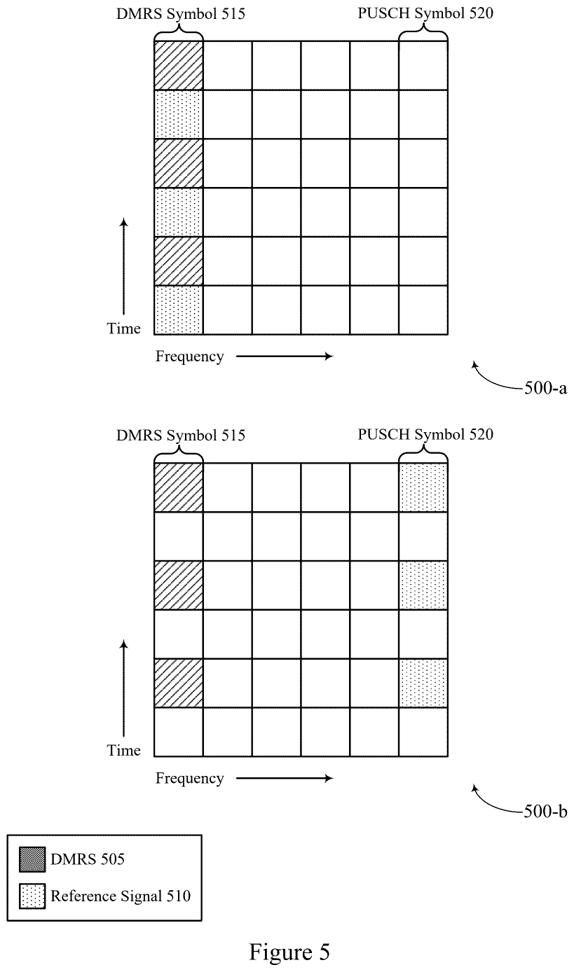

FIG. 5 shows examples of resource configurations 500 (e.g., a resource configuration 500-a and a resource configuration 500-b) that supports multi-port transmissions during initial access. The resource configurations 500 may implement or be implemented by aspects of the wireless communication system 100, the signaling diagram 200, the RO configurations 300, the RO formats 400, or any combination thereof. For example, the resource configurations 500 may be implemented by one or more UEs 115, one or more network entities 105, or both, which may be examples of the corresponding devices described herein, including with reference to FIG. 1.

In some cases, a RA procedure may be a two-step RA procedure, such that multi-port RACH transmissions, as described herein, may similarly be applied for the two-step RA procedure. That is, a RACH message may be msgA of the two-step RA procedure, such that a UE 115 may transmit a first portion of the msgA via a first port and may transmit a second portion of the msgA via a second port.

Alternatively, the UE 115 may support multi-port reference signal transmissions in a msgA PUSCH. In some cases, according to the resource configuration 500-a, the UE 115 may include one or more reference signals 510 in one or more demodulation reference signal (DMRS) symbols 515 in the msgA PUSCH to sound another port. For example, transmission of the msgA PUSCH may occur over a set of symbols, where the set of symbols includes one or more symbols carrying DMRS, which may be referred to as DMRS symbols 515, and one or more symbols carrying data (e.g., PUSCH), which may be referred to as PUSCH symbols 520. Thus, in some cases, in a DMRS symbol 515, the UE 115 may transmit one or more DMRSs 505 via a first port and may transmit one or more reference signals 510 via a second port, where the one or more DMRSs 505 and the one or more reference signals 510 are transmitted via different frequency resources. In other words, msgA PUSCH (e.g., or msg3 PUSCH) may use one DMRS port (e.g., in the DMRS symbol 515) while another port in the DMRS symbol 515 may be used to transmit the one or more reference signals 510 for multi-port sounding.

In some other cases, according to the resource configuration 500-b, the UE 115 may include one or more reference signals 510 in a PUSCH symbol 520 to sound another port. For example, as described herein, transmission of the msgA PUSCH may occur over the set of symbols including one or more DMRS symbols 515 and one or more PUSCH symbols 520. Thus, in some cases, the UE 115 may transmit one or more DMRSs 505 via the first port (e.g., via a DMRS symbol 515) and may transmit one or more reference signals 510 via the second port (e.g., via a PUSCH symbol 520), where the one or more DMRSs 505 and the one or more reference signals 510 are transmitted via the same frequency resources (e.g., and different time resources). In other words, msgA PUSCH (e.g., or msg3 PUSCH) may include the one or more reference signals 510 for another port in the PUSCH symbol 520 for multi-port sounding.

Similar techniques may be used for msg3 PUSCH of a four-step RA procedure. For example, msg3 PUSCH may include one or more reference signals 510 in a DMRS symbol 515 to sound another port (e.g., as described with reference to the resource configuration 500-a). Alternatively, the one or more reference signals 510 transmitted on another port may be included in one of the msg3 PUSCH symbols 520 (e.g., as described with reference to the resource configuration 500-b).

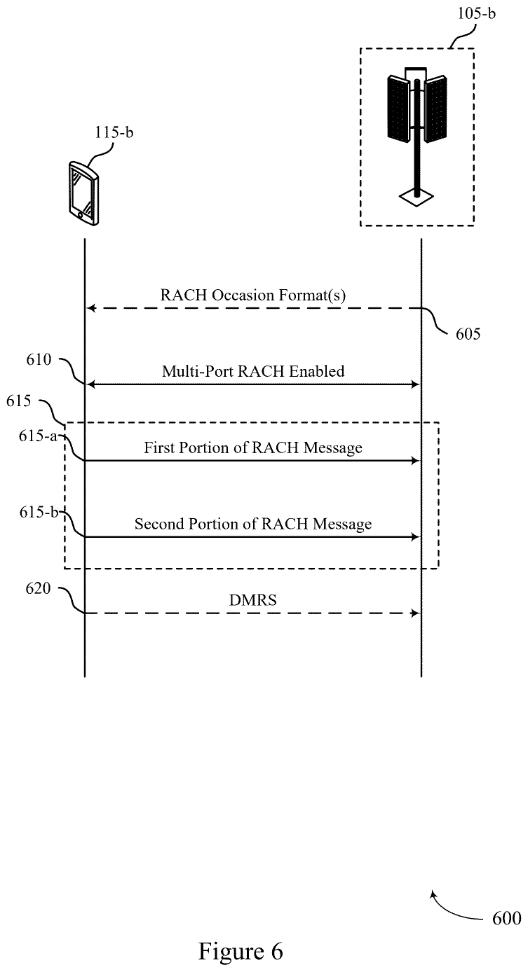

FIG. 6 shows an example of a process flow 600 that supports multi-port transmissions during initial access. The process flow 600 may implement or be implemented by aspects of the wireless communication system 100, the signaling diagram 200, the RO configurations 300, the RO formats 400, the resource configurations 500, or any combination thereof. For example, the process flow 600 may include one or more UEs 115 (e.g., a UE 115-b), one or more network entities 105 (e.g., a network entity 105-b), or both, which may be examples of the corresponding devices described herein, including with reference to FIG. 1.

In some cases, at 605, the UE 115-b may receive one or more control messages indicative of multiple RO formats. For example, the multiple RO formats may include a first RO format that supports multi-port RACH transmissions, a second RO format that supports single-port RACH transmissions and is associated with a first duration, a third RO format that supports single-port RACH transmissions and is associated with a second duration greater than the first duration, or any combination thereof. In some cases, the first RO format may also support single-port RACH transmissions from multiple UEs 115.

At 610, the UE 115-b may participate in communication of (e.g., transmit or receive) one or more signals that enable multi-port RACH transmissions. In some cases, the one or more signals may include a second control message, received by the UE 115-b from the network entity 105-b, indicative of the first RO format of the multiple RO formats, such that enablement of the multi-port RACH transmissions is based on the first RO format supporting multi-port RACH transmissions. Additionally, or alternatively, the one or more signals may include a multi-port downlink signal, received by the UE 115-b from the network entity 105-b, such that enablement of the multi-port RACH transmissions is based on measurement of the multi-port downlink signal. Additionally, or alternatively, the one or more signals may include one or more third control messages, received by the UE 115-b from the network entity 105-b, indicative of configuration information for multi-port RACH transmissions, such that enablement of the multi-port RACH transmissions is in response to reception of the one or more third control messages. Additionally, or alternatively, the one or more signals may include an uplink WUS, transmitted by the UE 115-b, indicative of a request to enable multi-port RACH transmissions, such that enablement of the multi-port RACH transmissions is in response to transmission of the uplink WUS. In some cases, enablement of the multi-port RACH transmissions is based on an RSRP associated with the UE 115-b satisfying a threshold (e.g., the UE 115-b being a high geometry UE 115)

At 615, the UE 115-b may transmit a RACH message via multiple ports of the UE based on the multi-port RACH transmissions being enabled. In such cases, transmission of the RACH message may include, at 615-a, transmitting, via a first port of the multiple ports of the UE, a first portion of the RACH message indicative of a first subset of sequences and, at 615-b, transmitting, via a second port of the multiple ports, a second portion of the RACH message indicative of a second subset of sequences, wherein the first port is different from the second port. In such cases, the first subset of sequences and the second subset of sequences each include multiple repetitions of a first sequence (e.g., RACH sequence).

In some examples, the UE 115-b may transmit the RACH message during (e.g., via) a multi-port RO (e.g., super RO) including multiple single-port ROs. In such cases, the UE 115-b may transmit the first portion of the RACH message during a first single-port RO of the multiple single-port ROs and may transmit the second portion of the RACH message during a second single-port RO of the multiple single-port ROs. In some cases, a beginning of the second single-port RO may occur a duration after an end of the first single-port RO and, in such cases, each of the first portion of the RACH message and the second portion of the RACH message may include a CP and a guard interval (e.g., GT) based on the beginning of the second single-port RO occurring the duration after the end of the first single-port RO. In some other cases, a beginning of the second single-port RO may be subsequent to an end of the first single-port RO (e.g., back-to-back single port ROs) and, in such cases, a guard interval (e.g., GT) may be absent from the first portion of the RACH message based on the beginning of the second single-port RO being subsequent to the end of the first single-port RO.

In some other cases, the UE 115-b may transmit the RACH message during a multi-port RO with a CP insertion (e.g., a multi-port RO without multiple single-port ROs). In such cases, the UE 115-b may transmit the first portion of the RACH message during a first portion of the multi-port RO and may transmit the second portion of the RACH message during a second portion of the multi-port RO. In such cases, the second portion of the RACH message may include (e.g., start with) a CP subsequent to an end of the first portion of the RACH message based on the first portion of the RACH message and the second portion of the RACH message being transmitted during a same RO.

In some cases, the UE 115-b may transmit the RACH message in accordance with a TA compensation based on the first portion of the RACH message and the second portion of the RACH message being transmitted during a same RO. Additionally, or alternatively, the UE 115-b may transmit first portion of the RACH message is transmitted in accordance with a first TA and may transmit the second portion of the RACH message in accordance with a second TA, different from the first timing advance. In some cases, the UE 115-b may receive a msg2 of a RA procedure indicating the first TA and the second TA. In some other cases, the UE 115-b may transmit first portion of the RACH message the second portion of the RACH message in accordance with a same TA.

In some cases (e.g., when the RACH message includes one or more DMRSs), at 620, the UE 115-b may transmit, via a third port of the multiple ports, one or more other reference signals based on the multi-port RACH transmissions being enabled. In some cases, the UE 115-b may transmit the one or more DMRSs and the one or more other reference signals via a same set of time resources (e.g., a same DMRS symbol) or via a same set of frequency resources.

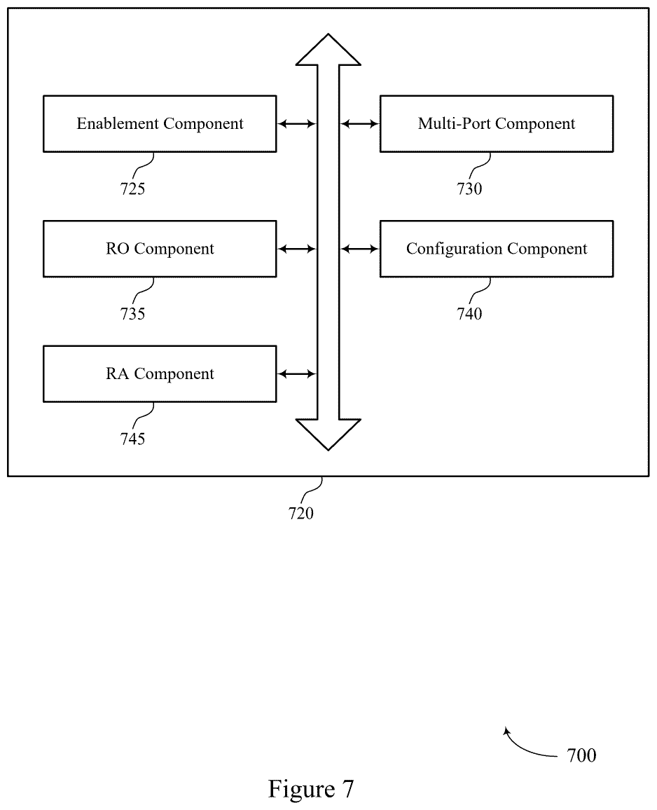

FIG. 7 shows an example 700 of a processing system 720 that supports two-port transmissions during initial access. A processing system 720 may be an example of a processing system 140 (such as of a UE 115) and may include an enablement component 725, a multi-port component 730, a RO component 735, a configuration component 740, a RA component 745, or any combination thereof. A processing system 720, or various component thereof, may be an example of means for performing (such as a means for causing a UE 115 to perform) various techniques described herein.

The enablement component 725 may be configured to cause the UE 115 to communicate, with a network entity, one or more signals that enable multi-port RACH transmissions. The multi-port component 730 may be configured to cause the UE 115 to transmit, to the network entity, a RACH message via a set of multiple ports of the UE based on multi-port RACH transmissions being enabled, where the RACH message indicates a set of multiple sequences. In some examples, to transmit the RACH message, the multi-port component 730 is capable of, configured to, or operable to support a means for transmitting, via a first port of the set of multiple ports of the UE, a first portion of the RACH message indicative of a first subset of set of multiple sequences and the multi-port component 730 is capable of, configured to, or operable to support a means for transmitting, via a second port of the set of multiple ports, a second portion of the RACH message indicative of a second subset of set of multiple sequences, where the first port is different from the second port.

In some examples, the first subset of set of multiple sequences and the second subset of set of multiple sequences each include a set of multiple repetitions of a first sequence.

In some examples, the RACH message is transmitted in accordance with a timing advance compensation based on the first portion of the RACH message and the second portion of the RACH message being transmitted during a same RO.

In some examples, to support transmitting the RACH message via the set of multiple ports, the RO component 735 may be configured to cause the UE 115 to transmit the first portion of the RACH message during a first single-port RO of the set of multiple single-port ROs. In some examples, to support transmitting the RACH message via the set of multiple ports, the RO component 735 may be configured to cause the UE 115 to transmit the second portion of the RACH message during a second single-port RO of the set of multiple single-port ROs.

In some examples, a beginning of the second single-port RO occurs a duration after an end of the first single-port RO. In some examples, each of the first portion of the RACH message and the second portion of the RACH message include a cyclic prefix and a guard interval based on the beginning of the second single-port RO occurring the duration after the end of the first single-port RO.

In some examples, a beginning of the second single-port RO is subsequent to an end of the first single-port RO. In some examples, a guard interval is absent from the first portion of the RACH message based on the beginning of the second single-port RO being subsequent to the end of the first single-port RO.

In some examples, to support transmitting the RACH message via the set of multiple ports, the RO component 735 may be configured to cause the UE 115 to transmit the first portion of the RACH message during a first portion of the RO. In some examples, to support transmitting the RACH message via the set of multiple ports, the RO component 735 may be configured to cause the UE 115 to transmit the second portion of the RACH message during a second portion of the RO, where the second portion of the RACH message includes a cyclic prefix subsequent to an end of the first portion of the RACH message based on the first portion of the RACH message and the second portion of the RACH message being transmitted during a same RO.

In some examples, multi-port RACH transmission is enabled based on a reference signal receive power associated with the UE satisfying a threshold.

In some examples, to support communicating the one or more signals that enables the multi-port RACH transmissions, the enablement component 725 may be configured to cause the UE 115 to receive a multi-port downlink signal, where enablement of the multi-port RACH transmissions is based on measurement of the multi-port downlink signal.

In some examples, to support communicating the one or more signals that enables the multi-port RACH transmissions, the enablement component 725 may be configured to cause the UE 115 to receive one or more control messages indicative of configuration information for multi-port RACH transmissions, where enablement of the multi-port RACH transmissions is in response to reception of the one or more control messages.

In some examples, to support communicating the one or more signals that enables the multi-port RACH transmissions, the enablement component 725 may be configured to cause the UE 115 to transmit an uplink WUS indicative of a request to enable multi-port RACH transmissions, where enablement of the multi-port RACH transmissions is in response to transmission of the uplink WUS.

In some examples, the configuration component 740 may be configured to cause the UE 115 to receive one or more control messages indicative of a set of multiple RO formats. In some examples, to communicate the one or more signals that enable the multi-port RACH transmissions, the enablement component 725 is capable of, configured to, or operable to support a means for receiving a second control message indicative of a first RO format of the set of multiple RO formats, where enablement of the multi-port RACH transmissions is based on the first RO format supporting multi-port RACH transmissions.

In some examples, the set of multiple RO formats include the first RO format that supports multi-port RACH transmissions, a second RO format that supports single-port RACH transmissions and is associated with a first duration, a third RO format that supports single-port RACH transmissions and is associated with a second duration greater than the first duration, or any combination thereof.

In some examples, the first RO format further supports single-port RACH transmissions from a set of multiple UEs.

In some examples, the first portion of the RACH message is transmitted in accordance with a first timing advance. In some examples, the second portion of the RACH message is transmitted in accordance with a second timing advance, different from the first timing advance.

In some examples, the RA component 745 may be configured to cause the UE 115 to receive, via a second message of a random access procedure, an indication of the first timing advance and the second timing advance.

In some examples, the first portion of the RACH message and the second portion of the RACH message are transmitted in accordance with a same timing advance.

In some examples, the RACH message includes one or more DMRSs, and the multi-port component 730 may be configured to cause the UE 115 to transmit, via a third port of the set of multiple ports, one or more other reference signals based on the multi-port RACH transmissions being enabled.

In some examples, the one or more DMRSs and the one or more other reference signals are transmitted via a same set of time resources.

In some examples, the one or more DMRSs and the one or more other reference signals are transmitted via a same set of frequency resources.

A processing system 720 may include or be a component of one or more chips, systems-on-chips (SoCs), chipsets, packages, components, or devices that individually or collectively constitute or include a processing system. A processing system 720 may interface with other components of a processing system 720. For example, operations described with reference to a processing system 720, or various components thereof, may be performed by or with other such components, including a receiver, a transmitter, a transceiver, a modem, a user interface, a modulator/demodulator, an encoder/decoder, or any combination thereof (such as of the processing system 720, coupled with the processing system 720, of a processing system 720).

By including or configuring a processing system 720 for operation in a processing system 720 as described herein, the processing system 720 may support techniques for multi-port RACH transmissions, which may result in improved communication reliability, reduced latency, improved user experience related to reduced processing, reduced power consumption, more efficient utilization of communication resources, improved coordination between devices, longer battery life, and improved utilization of processing capability, among other advantages.

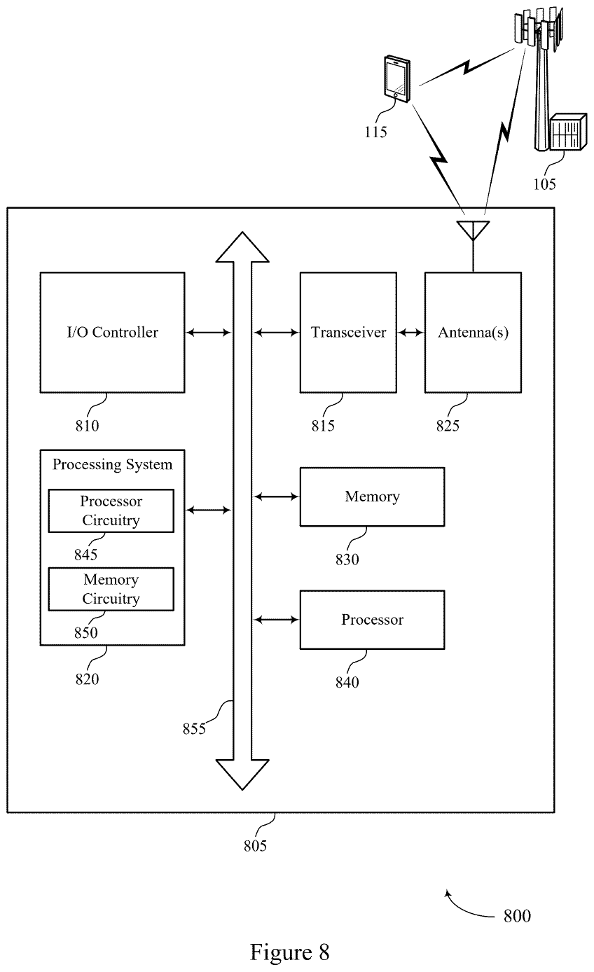

FIG. 8 shows an example of a system 800 including a device 805 that supports two-port transmissions during initial access. The device 805 may be an example of or include components of UE 115. The device 805 may communicate (such as wirelessly) with one or more other devices (such as network entities 105, UEs 115). The device 805 may include components for transmitting and receiving communication, which may include a processing system 820, an input/output (I/O) controller, such as an I/O controller 810, a transceiver 815, antenna(s) 825, a memory 830, and a processor 840. Components of the device 805 may be coupled (such as operatively, communicatively, functionally, electronically, electrically, in electronic communication) a bus 855.

The transceiver 815 may support bi-directional communication via antenna(s) 825, and may support transmission operations, reception operations, or both, as described herein. The transceiver 815 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 805). The transceiver 815 may modulate symbols and provide the modulated symbols to antenna(s) 825 for transmission, and demodulate symbols from signals received using antenna(s) 825.

The processor 840 may be a general-purpose processing component that supports various operations (such as applications) of the device 805. The memory 830 may be a general-purpose storage component that stores code executable by the processor 840. Such code may include instructions that, when executed by the processor 840, cause the device 805 to perform various functions (such as to support an application of the device 805). The I/O controller 810 may manage inputs and outputs for the device 805, may manage peripherals not integrated into the device 805, or may represent a physical connection (such as port) to an external peripheral. The processor 840 may interact with a modem, a keyboard, a mouse, a touchscreen, or other device (such as via I/O controller 810). In some implementations, a user may interact with the device 805 via the I/O controller 810 or via hardware components controlled by the I/O controller 810.

The processing system 820 may be an example of a processing system 140 or a processing system 720. For example, the processing system 820 may include processor circuitry 845 and memory circuitry 850 that stores code, and may be configured to cause the device 805 to perform operations that support two-port transmissions during initial access. Although the processing system 820 is illustrated as a separate component, which may involve a separate chip, chipset, or other module, in some implementations, one or more functions described with reference to the processing system 820 may be supported by or performed by a transceiver 815, antenna(s) 825, a processor 840, memory 830, or any combination thereof, such that a processing system 820 may include one or more of a transceiver 815, antenna(s) 825, a processor 840, memory 830, or any combination thereof.

By including or configuring the processing system 820 for operation in the device 805 as described herein, may support techniques for multi-port RACH transmissions, which may result in improved communication reliability, reduced latency, improved user experience related to reduced processing, reduced power consumption, more efficient utilization of communication resources, improved coordination between devices, longer battery life, and improved utilization of processing capability, among other advantages.

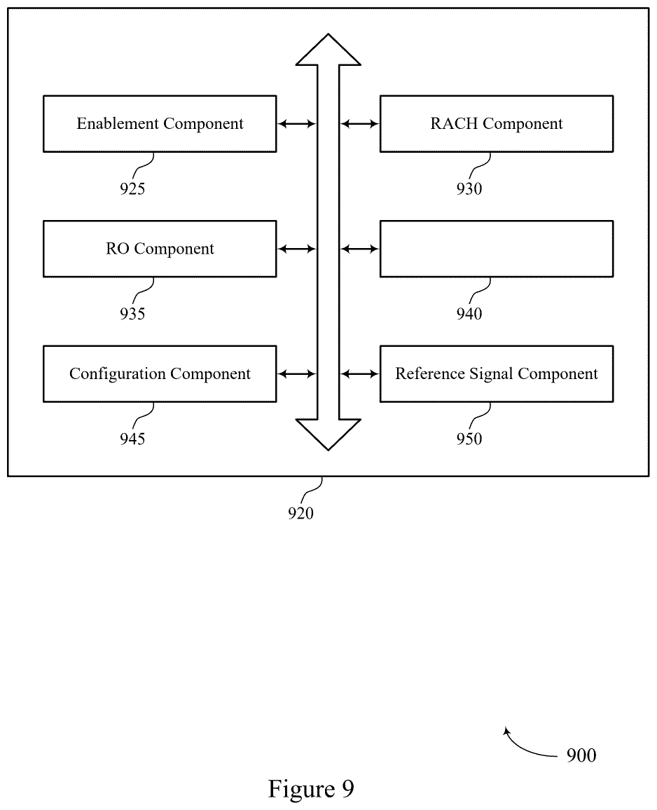

FIG. 9 shows an example 900 of a processing system 920 that supports two-port transmissions during initial access. A processing system 920 may be an example of a processing system 145 (such as network entity 105) and may include an enablement component 925, a RACH component 930, a RO component 935, a configuration component 945, a reference signal component 950, or any combination thereof. A processing system 920, or various component thereof, may be an example of means for performing (such as a means for causing a network entity 105 to perform) various techniques described herein.

The enablement component 925 may be configured to cause the network entity 105 to communicate, with a UE, one or more signals that enable multi-port RACH transmissions. The RACH component 930 may be configured to cause the network entity 105 to receive, from the UE, a RACH message based on multi-port RACH transmissions being enabled, where the RACH message indicates a set of multiple sequences. In some examples, to receive the RACH message, the RACH component 930 is capable of, configured to, or operable to support a means for receiving a first portion of the RACH message indicative of a first subset of the set of multiple sequences and the RACH component 930 is capable of, configured to, or operable to support a means for receiving a second portion of the RACH message indicative of a second subset of the set of multiple sequences.

In some examples, the first subset of the set of multiple sequences and the second subset of the set of multiple sequences each include a set of multiple repetitions of a first sequence.

In some examples, the RACH message is received in accordance with a timing advance compensation based on the first portion of the RACH message and the second portion of the RACH message being received during a same RO.

In some examples, to support receiving the RACH message, the RO component 935 may be configured to cause the network entity 105 to receive the first portion of the RACH message during a first single-port RO of the set of multiple single-port ROs. In some examples, to support receiving the RACH message, the RO component 935 may be configured to cause the network entity 105 to receive the second portion of the RACH message during a second single-port RO of the set of multiple single-port ROs.

In some examples, a beginning of the second single-port RO occurs a duration after an end of the first single-port RO. In some examples, each of the first portion of the RACH message and the second portion of the RACH message include a cyclic prefix and a guard interval based on the beginning of the second single-port RO occurring the duration after the end of the first single-port RO.

In some examples, a beginning of the second single-port RO is subsequent to an end of the first single-port RO. In some examples, a guard interval is absent from the first portion of the RACH message based on the beginning of the second single-port RO being subsequent to the end of the first single-port RO.

In some examples, to support receiving the RACH message, the RO component 935 may be configured to cause the network entity 105 to receive the first portion of the RACH message during a first portion of the RO. In some examples, to support receiving the RACH message, the RO component 935 may be configured to cause the network entity 105 to receive the second portion of the RACH message during a second portion of the RO, where the second portion of the RACH message includes a cyclic prefix subsequent to an end of the first portion of the RACH message based on the first portion of the RACH message and the second portion of the RACH message being transmitted during a same RO.

In some examples, to support communicating the one or more signals that enables the multi-port RACH transmissions, the enablement component 925 may be configured to cause the network entity 105 to transmit a multi-port downlink signal, where enablement of the multi-port RACH transmissions is based on the multi-port downlink signal.

In some examples, to support communicating the one or more signals that enables the multi-port RACH transmissions, the enablement component 925 may be configured to cause the network entity 105 to transmit one or more control messages indicative of configuration information for multi-port RACH transmissions, where enablement of the multi-port RACH transmissions is in response to transmission of the one or more control messages.

In some examples, to support communicating the one or more signals that enables the multi-port RACH transmissions, the 940 may be configured to cause the network entity 105 to receive an uplink WUS indicative of a request to enable multi-port RACH transmissions, where enablement of the multi-port RACH transmissions is in response to transmission of the uplink WUS.

In some examples, the configuration component 945 may be configured to cause the network entity 105 to transmit one or more control messages indicative of a set of multiple RO formats. In some examples, to communicate the one or more signals that enable the multi-port RACH transmissions, the enablement component 925 is capable of, configured to, or operable to support a means for transmitting a second control message indicative of a first RO format of the set of multiple RO formats, where enablement of the multi-port RACH transmissions is based on the first RO format supporting multi-port RACH transmissions.

In some examples, the set of multiple RO formats include the first RO format that supports multi-port RACH transmissions, a second RO format that supports single-port RACH transmissions and is associated with a first duration, a third RO format that supports single-port RACH transmissions and is associated with a second duration greater than the first duration, or any combination thereof.

In some examples, the first RO format further supports single-port RACH transmissions from a set of multiple UEs.

In some examples, the first portion of the RACH message is received in accordance with a first timing advance. In some examples, the second portion of the RACH message is received in accordance with a second timing advance, different from the first timing advance.

In some examples, the RACH component 930 may be configured to cause the network entity 105 to transmit, via a second message of a random access procedure, an indication of the first timing advance and the second timing advance.

In some examples, the first portion of the RACH message and the second portion of the RACH message are received in accordance with a same timing advance.

In some examples, the RACH message includes one or more DMRSs, and the reference signal component 950 may be configured to cause the network entity 105 to receive one or more other reference signals based on the multi-port RACH transmissions being enabled.

In some examples, the one or more DMRSs and the one or more other reference signals are received via a same set of time resources.

In some examples, the one or more DMRSs and the one or more other reference signals are received via a same set of frequency resources.

A processing system 920 may include or be an example of one or more chips, SoCs, chipsets, packages, components, or devices that individually or collectively constitute or include a processing system. A processing system 920 may interface with other components of a network entity 105. For example, operations described with reference to a processing system 920, or various components thereof, may be performed by or with other such components, including a receiver, a transmitter, a transceiver, a modem, a user interface, a modulator/demodulator, an encoder/decoder, or any combination thereof (such as of the processing system 920, coupled with the processing system 920, of a network entity 105). Operations described herein with reference to the processing system 920, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 920 for operation in a processing system 920 as described herein, the processing system 920 may support techniques for multi-port RACH transmissions, which may result in improved communication reliability, reduced latency, improved user experience related to reduced processing, reduced power consumption, more efficient utilization of communication resources, improved coordination between devices, longer battery life, and improved utilization of processing capability, among other advantages.

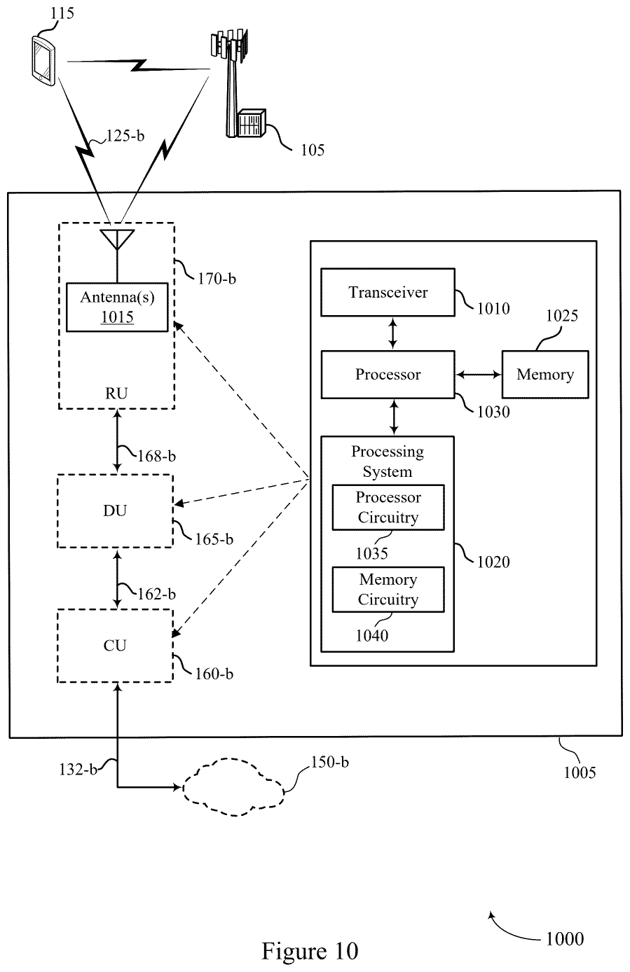

FIG. 10 shows an example of a system 1000 including a device 1005 that supports two-port transmissions during initial access. The device 1005 may communicate (such as via one or more wired interfaces or one or more wireless interfaces) with other network devices or network equipment such as a core network 150-b, other network entities 105, UEs 115, or any combination thereof. The device 1005 may include components for transmitting and receiving communication, which may include a processing system 1020, a transceiver 1010, antenna(s) 1015, a memory 1025, and a processor 1030. Components of the device 1005 may be coupled (such as operatively, communicatively, functionally, electronically, electrically, in electronic communication) via one or more interfaces.

The transceiver 1010 may communicate bi-directionally with another transceiver via wired or wireless links, and may support transmission operations, reception operations, or both, as described herein. The transceiver 1010 may include a modem to modulate and demodulate signals, to provide the modulated signals for transmission (such as via antenna(s) 1015, via a wired interface), and to demodulate received signals (such as received via antenna(s) 1015, received via a wired interface). The transceiver 1010 may be operable to support communication via one or more communication links (such as a communication link 125-b, a backhaul link 132-b, a midhaul link 162-b, fronthaul link 168-b).

The processor 1030 may be a general-purpose processing component that supports various operations (such as applications) of the device 1005. The memory 1025 may be a general-purpose storage component that stores code executable by the processor 1030. Such code may include instructions that, when executed by the processor 1030, cause the device 1005 to perform various functions (such as to support an application of the device 1005).

For examples in which the device 1005 is a network entity 105 in a disaggregated architecture, one or more components of the device 1005 may be located at one or more of a CU 160-b, a DU 165-b, or an RU 170-b, one or more of which may include aspects of the processing system 1020, the processor 1030, the memory 1025, or the transceiver 1010. Functions of the device 1005 may be performed at different components or an operation may be divided between different components (such as different functions being supported by aspects of the CU 160-b, the DU 165-b, or the RU 170-b, the transceiver 1010, the processor 1030, the memory 1025, the processing system 1020, or any combination thereof). For example, the processing system 1020 may be a component of one or more of the CU 160-b, the DU 165-b, or the RU 170-b. In some examples, interfaces between components of device 1005 (such as CU 160-b, DU 165-b, RU 170-b) may support communication at a protocol layer or between protocol layers of a protocol stack.

In some examples, the processing system 1020 may manage aspects of communication with the core network 150-b (such as via a backhaul link 132). For example, the processing system 1020 may manage the transfer of data communication for UEs 115 with a gateway of the core network 150-b. In some examples, the processing system 1020 may manage communication with one or more other network entities 105 and may include a controller or scheduler for controlling communication with UEs 115 (such as in cooperation with the one or more other network entities 105). In some examples, the processing system 1020 may support an interface (such as X2 interface, Xn interface) to provide communication between network entities 105.

The processing system 1020 may be an example of a processing system 145 or a processing system 920. For example, the processing system 1020 may include processor circuitry 1035 and memory circuitry 1040 that stores code, and the processing system 1020 may be configured to cause the device 1005 to perform operations that support two-port transmissions during initial access. Although the processing system 1020 is illustrated as a separate component, which may involve a separate chip, chipset, or other module, in some implementations, one or more functions described with reference to the processing system 1020 may be supported by or performed by a transceiver 1010, antenna(s) 1015, a processor 1030, memory 1025, or any combination thereof, such that a processing system 1020 may include one or more of a transceiver 1010, antenna(s) 1015, a processor 1030, memory 1025, or any combination thereof. Further, processor circuitry 1035 and memory circuitry 1040 each may be implemented at the device 1005 in accordance with an aggregated architecture, or the processor circuitry 1035 and the memory circuitry 1040 may be implemented at one or more of a CU 160-b, a DU 165-b, or an RU 170-b in accordance with a disaggregated architecture.

By including or configuring the processing system 1020 for operation in the device 1005 as described herein, may support techniques for multi-port RACH transmissions, which may result in improved communication reliability, reduced latency, improved user experience related to reduced processing, reduced power consumption, more efficient utilization of communication resources, improved coordination between devices, longer battery life, and improved utilization of processing capability, among other advantages.

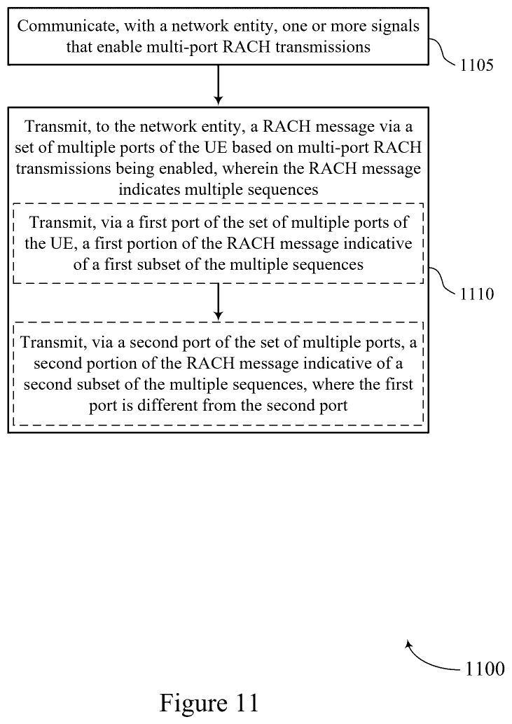

FIG. 11 shows an example of a method 1100 that supports two-port transmissions during initial access. Operations of the method 1100 may be performed by a UE or its components (such as using a processing system configured to cause the UE 115 to perform one or more of the operations) as described herein.

At 1105, the method may include communicating, with a network entity, one or more signals that enable multi-port RACH transmissions. In some examples, aspects of the operations of 1105 may be performed by an enablement component 725.

At 1110, the method may include transmitting, to the network entity, a RACH message via a set of multiple ports of the UE based on multi-port RACH transmissions being enabled, where the RACH message indicates a set of multiple sequences. In some examples, transmitting the RACH message may include transmitting, via a first port of the set of multiple ports of the UE, a first portion of the RACH message indicative of a first subset of the set of multiple sequences and transmitting, via a second port of the set of multiple ports, a second portion of the RACH message indicative of a second subset of the set of multiple sequences, where the first port is different from the second port. In some examples, aspects of the operations of 1110 may be performed by a multi-port component 730.

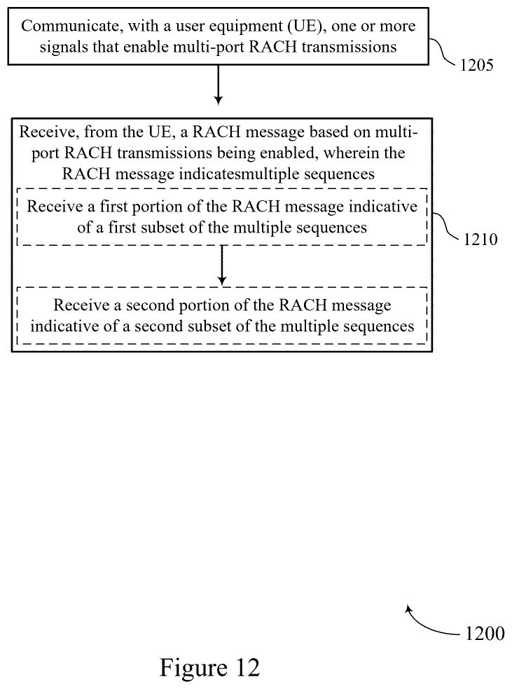

FIG. 12 shows an example of a method 1200 that supports two-port transmissions during initial access. Operations of the method 1200 may be performed by a network entity 105 or its components (such as using a processing system configured to cause the network entity to perform one or more operations) as described herein.

At 1205, the method may include communicating, with a UE, one or more signals that enable multi-port RACH transmissions. In some examples, aspects of the operations of 1205 may be performed by an enablement component 925.

At 1210, the method may include receiving, from the UE, a RACH message based on multi-port RACH transmissions being enabled, where the RACH message indicates a set of multiple sequences. In some examples, receiving the RACH message may include receiving a first portion of the RACH message indicative of a first subset of the set of multiple sequences and receiving a second portion of the RACH message indicative of a second subset of the set of multiple sequences. In some examples, aspects of the operations of 1210 may be performed by a RACH component 930.

Implementation examples are described in the following numbered clauses:
Aspect 1: A method for wireless communications at a UE, comprising: communicating, with a network entity, one or more signals that enable multi-port RACH transmissions; and transmitting, to the network entity, a RACH message via a plurality of ports of the UE based at least in part on multi-port RACH transmissions being enabled, wherein the RACH message indicates a plurality of sequences, and wherein transmitting the RACH message comprises: transmitting, via a first port of the plurality of ports of the UE, a first portion of the RACH message indicative of a first subset of the plurality of sequences; and transmitting, via a second port of the plurality of ports, a second portion of the RACH message indicative of a second subset of the plurality of sequences, wherein the first port is different from the second port.
Aspect 2: The method of aspect 1, wherein the first subset of the plurality of sequences and the second subset of the plurality of sequences each comprise a plurality of repetitions of a first sequence.
Aspect 3: The method of any of aspects 1 through 2, wherein the RACH message is transmitted in accordance with a timing advance compensation based at least in part on the first portion of the RACH message and the second portion of the RACH message being transmitted during a same RO.
Aspect 4: The method of any of aspects 1 through 3, wherein the RACH message is transmitted during a multi-port RO comprising a plurality of single-port ROs, and wherein transmitting the RACH message via the plurality of ports comprises: transmitting the first portion of the RACH message during a first single-port RO of the plurality of single-port ROs; and transmitting the second portion of the RACH message during a second single-port RO of the plurality of single-port ROs.
Aspect 5: The method of aspect 4, wherein a beginning of the second single-port RO occurs a duration after an end of the first single-port RO, and each of the first portion of the RACH message and the second portion of the RACH message comprise a cyclic prefix and a guard interval based at least in part on the beginning of the second single-port RO occurring the duration after the end of the first single-port RO.
Aspect 6: The method of any of aspects 4 through 5, wherein a beginning of the second single-port RO is subsequent to an end of the first single-port RO, and a guard interval is absent from the first portion of the RACH message based at least in part on the beginning of the second single-port RO being subsequent to the end of the first single-port RO.
Aspect 7: The method of any of aspects 1 through 6, wherein the RACH message is transmitted during a RO, and wherein transmitting the RACH message via the plurality of ports comprises: transmitting the first portion of the RACH message during a first portion of the RO; and transmitting the second portion of the RACH message during a second portion of the RO, wherein the second portion of the RACH message comprises a cyclic prefix subsequent to an end of the first portion of the RACH message based at least in part on the first portion of the RACH message and the second portion of the RACH message being transmitted during a same RO.
Aspect 8: The method of any of aspects 1 through 7, wherein multi-port RACH transmission is enabled based at least in part on a reference signal receive power associated with the UE satisfying a threshold.
Aspect 9: The method of any of aspects 1 through 8, wherein communicating the one or more signals that enables the multi-port RACH transmissions comprises: receiving a multi-port downlink signal, wherein enablement of the multi-port RACH transmissions is based at least in part on measurement of the multi-port downlink signal.
Aspect 10: The method of any of aspects 1 through 9, wherein communicating the one or more signals that enables the multi-port RACH transmissions comprises: receiving one or more control messages indicative of configuration information for multi-port RACH transmissions, wherein enablement of the multi-port RACH transmissions is in response to reception of the one or more control messages.
Aspect 11: The method of any of aspects 1 through 10, wherein communicating the one or more signals that enables the multi-port RACH transmissions comprises: transmitting an uplink WUS indicative of a request to enable multi-port RACH transmissions, wherein enablement of the multi-port RACH transmissions is in response to transmission of the uplink WUS.
Aspect 12: The method of any of aspects 1 through 11, further comprising: receiving one or more control messages indicative of a plurality of RO formats, wherein communicating the one or more signals that enable the multi-port RACH transmissions comprises: receiving a second control message indicative of a first RO format of the plurality of RO formats, wherein enablement of the multi-port RACH transmissions is based at least in part on the first RO format supporting multi-port RACH transmissions.
Aspect 13: The method of aspect 12, wherein the plurality of RO formats comprise the first RO format that supports multi-port RACH transmissions, a second RO format that supports single-port RACH transmissions and is associated with a first duration, a third RO format that supports single-port RACH transmissions and is associated with a second duration greater than the first duration, or any combination thereof.
Aspect 14: The method of any of aspects 12 through 13, wherein the first RO format further supports single-port RACH transmissions from a plurality of UEs.
Aspect 15: The method of any of aspects 1 through 14, wherein the first portion of the RACH message is transmitted in accordance with a first timing advance, and the second portion of the RACH message is transmitted in accordance with a second timing advance, different from the first timing advance.
Aspect 16: The method of aspect 15, further comprising: receiving, via a second message of a random access procedure, an indication of the first timing advance and the second timing advance.
Aspect 17: The method of any of aspects 1 through 16, wherein the first portion of the RACH message and the second portion of the RACH message are transmitted in accordance with a same timing advance.
Aspect 18: The method of any of aspects 1 through 17, wherein the RACH message comprises one or more DMRSs, the method further comprising: transmitting, via a third port of the plurality of ports, one or more other reference signals based at least in part on the multi-port RACH transmissions being enabled.
Aspect 19: The method of aspect 18, wherein the one or more DMRSs and the one or more other reference signals are transmitted via a same set of time resources.
Aspect 20: The method of any of aspects 18 through 19, wherein the one or more DMRSs and the one or more other reference signals are transmitted via a same set of frequency resources.
Aspect 21: A method for wireless communications at a network entity, comprising: communicating, with a UE, one or more signals that enable multi-port RACH transmissions; and receiving, from the UE, a RACH message based at least in part on multi-port RACH transmissions being enabled, wherein the RACH message indicates a plurality of sequences, and wherein receiving the RACH message comprises: receiving a first portion of the RACH message indicative of a first subset of the plurality of sequences; and receiving a second portion of the RACH message indicative of a second subset of the plurality of sequences.
Aspect 22: The method of aspect 21, wherein the first subset of the plurality of sequences and the second subset of the plurality of sequences each comprise a plurality of repetitions of a first sequence.
Aspect 23: The method of any of aspects 21 through 22, wherein the RACH message is received in accordance with a timing advance compensation based at least in part on the first portion of the RACH message and the second portion of the RACH message being received during a same RO.
Aspect 24: The method of any of aspects 21 through 23, wherein the RACH message is received during a multi-port RO comprising a plurality of single-port ROs, and wherein receiving the RACH message comprises: receiving the first portion of the RACH message during a first single-port RO of the plurality of single-port ROs; and receiving the second portion of the RACH message during a second single-port RO of the plurality of single-port ROs.
Aspect 25: The method of aspect 24, wherein a beginning of the second single-port RO occurs a duration after an end of the first single-port RO, and each of the first portion of the RACH message and the second portion of the RACH message comprise a cyclic prefix and a guard interval based at least in part on the beginning of the second single-port RO occurring the duration after the end of the first single-port RO.
Aspect 26: The method of any of aspects 24 through 25, wherein a beginning of the second single-port RO is subsequent to an end of the first single-port RO, and a guard interval is absent from the first portion of the RACH message based at least in part on the beginning of the second single-port RO being subsequent to the end of the first single-port RO.
Aspect 27: The method of any of aspects 21 through 26, wherein the RACH message is received during a RO, and wherein receiving the RACH message comprises: receiving the first portion of the RACH message during a first portion of the RO; and receiving the second portion of the RACH message during a second portion of the RO, wherein the second portion of the RACH message comprises a cyclic prefix subsequent to an end of the first portion of the RACH message based at least in part on the first portion of the RACH message and the second portion of the RACH message being transmitted during a same RO.
Aspect 28: The method of any of aspects 21 through 27, wherein communicating the one or more signals that enables the multi-port RACH transmissions comprises: transmitting a multi-port downlink signal, wherein enablement of the multi-port RACH transmissions is based at least in part on the multi-port downlink signal.
Aspect 29: The method of any of aspects 21 through 28, wherein communicating the one or more signals that enables the multi-port RACH transmissions comprises: transmitting one or more control messages indicative of configuration information for multi-port RACH transmissions, wherein enablement of the multi-port RACH transmissions is in response to transmission of the one or more control messages.
Aspect 30: The method of any of aspects 21 through 29, wherein communicating the one or more signals that enables the multi-port RACH transmissions comprises: receiving an uplink WUS indicative of a request to enable multi-port RACH transmissions, wherein enablement of the multi-port RACH transmissions is in response to transmission of the uplink WUS.
Aspect 31: The method of any of aspects 21 through 30, further comprising: transmitting one or more control messages indicative of a plurality of RO formats, wherein communicating the one or more signals that enable the multi-port RACH transmissions comprises: transmitting a second control message indicative of a first RO format of the plurality of RO formats, wherein enablement of the multi-port RACH transmissions is based at least in part on the first RO format supporting multi-port RACH transmissions.
Aspect 32: The method of aspect 31, wherein the plurality of RO formats comprise the first RO format that supports multi-port RACH transmissions, a second RO format that supports single-port RACH transmissions and is associated with a first duration, a third RO format that supports single-port RACH transmissions and is associated with a second duration greater than the first duration, or any combination thereof.
Aspect 33: The method of aspect 32, wherein the first RO format further supports single-port RACH transmissions from a plurality of UEs.
Aspect 34: The method of any of aspects 21 through 33, wherein the first portion of the RACH message is received in accordance with a first timing advance, and the second portion of the RACH message is received in accordance with a second timing advance, different from the first timing advance.
Aspect 35: The method of aspect 34, further comprising: transmitting, via a second message of a random access procedure, an indication of the first timing advance and the second timing advance.
Aspect 36: The method of any of aspects 21 through 35, wherein the first portion of the RACH message and the second portion of the RACH message are received in accordance with a same timing advance.
Aspect 37: The method of any of aspects 21 through 36, wherein the RACH message comprises one or more DMRSs, the method further comprising: receiving one or more other reference signals based at least in part on the multi-port RACH transmissions being enabled.
Aspect 38: The method of aspect 37, wherein the one or more DMRSs and the one or more other reference signals are received via a same set of time resources.
Aspect 39: The method of any of aspects 37 through 38, wherein the one or more DMRSs and the one or more other reference signals are received via a same set of frequency resources.
Aspect 40: A UE for wireless communications, comprising a processing system that includes processor circuitry and memory circuitry that stores code, the processing system configured to cause the UE to perform a method of any of aspects 1 through 20.
Aspect 41: A UE for wireless communications, comprising at least one means for performing a method of any of aspects 1 through 20.
Aspect 42: A non-transitory computer-readable medium storing code for wireless communications, the code comprising instructions executable by one or more processors to perform a method of any of aspects 1 through 20.
Aspect 43: A network entity for wireless communications, comprising a processing system that includes processor circuitry and memory circuitry that stores code, the processing system configured to cause the network entity to perform a method of any of aspects 21 through 39.
Aspect 44: A network entity for wireless communications, comprising at least one means for performing a method of any of aspects 21 through 39.
Aspect 45: A non-transitory computer-readable medium storing code for wireless communications, the code comprising instructions executable by one or more processors to perform a method of any of aspects 21 through 39.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
communicate, with a network entity, one or more signals that enable multi-port random access channel (RACH) transmissions; and
transmit, to the network entity, a RACH message via a plurality of ports of the UE based at least in part on multi-port RACH transmissions being enabled, wherein the RACH message indicates a plurality of sequences, and wherein, to transmit the RACH message, the one or more processors are individually or collectively operable to execute the code to cause the UE to:
transmit, via a first port of the plurality of ports of the UE, a first portion of the RACH message indicative of a first subset of the plurality of sequences; and
transmit, via a second port of the plurality of ports, a second portion of the RACH message indicative of a second subset of the plurality of sequences, wherein the first port is different from the second port.

2. The UE of claim 1, wherein the first subset of the plurality of sequences and the second subset of the plurality of sequences each comprise a plurality of repetitions of a first sequence.

3. The UE of claim 1, wherein the RACH message is transmitted in accordance with a timing advance compensation based at least in part on the first portion of the RACH message and the second portion of the RACH message being transmitted during a same RACH occasion.

4. The UE of claim 1, wherein the RACH message is transmitted during a multi-port RACH occasion comprising a plurality of single-port RACH occasions, and wherein, to transmit the RACH message via the plurality of ports, the one or more processors are individually or collectively operable to execute the code to cause the UE to:
transmit the first portion of the RACH message during a first single-port RACH occasion of the plurality of single-port RACH occasions; and
transmit the second portion of the RACH message during a second single-port RACH occasion of the plurality of single-port RACH occasions.

5. The UE of claim 1, wherein the RACH message is transmitted during a RACH occasion, and wherein, to transmit the RACH message via the plurality of ports, the one or more processors are individually or collectively operable to execute the code to cause the UE to:
transmit the first portion of the RACH message during a first portion of the RACH occasion; and
transmit the second portion of the RACH message during a second portion of the RACH occasion, wherein the second portion of the RACH message comprises a cyclic prefix subsequent to an end of the first portion of the RACH message based at least in part on the first portion of the RACH message and the second portion of the RACH message being transmitted during a same RACH occasion.

6. The UE of claim 1, wherein multi-port RACH transmission is enabled based at least in part on a reference signal receive power associated with the UE satisfying a threshold.

7. The UE of claim 1, wherein, to communicate the one or more signals that enables the multi-port RACH transmissions, the one or more processors are individually or collectively operable to execute the code to cause the UE to:
receive a multi-port downlink signal, wherein enablement of the multi-port RACH transmissions is based at least in part on measurement of the multi-port downlink signal.

8. The UE of claim 1, wherein, to communicate the one or more signals that enables the multi-port RACH transmissions, the one or more processors are individually or collectively operable to execute the code to cause the UE to:
receive one or more control messages indicative of configuration information for multi-port RACH transmissions, wherein enablement of the multi-port RACH transmissions is in response to reception of the one or more control messages.

9. The UE of claim 1, wherein, to communicate the one or more signals that enables the multi-port RACH transmissions, the one or more processors are individually or collectively operable to execute the code to cause the UE to:
transmit an uplink wake-up signal indicative of a request to enable multi-port RACH transmissions, wherein enablement of the multi-port RACH transmissions is in response to transmission of the uplink wake-up signal.

10. The UE of claim 1, wherein the one or more processors are individually or collectively further operable to execute the code to cause the UE to:
receive one or more control messages indicative of a plurality of RACH occasion formats, wherein, to communicate the one or more signals that enable the multi-port RACH transmissions, the one or more processors are individually or collectively operable to execute the code to cause the UE to:
receive a second control message indicative of a first RACH occasion format of the plurality of RACH occasion formats, wherein enablement of the multi-port RACH transmissions is based at least in part on the first RACH occasion format supporting multi-port RACH transmissions.

11. The UE of claim 1, wherein the first portion of the RACH message is transmitted in accordance with a first timing advance, and wherein the second portion of the RACH message is transmitted in accordance with a second timing advance, different from the first timing advance.

12. The UE of claim 1, wherein the first portion of the RACH message and the second portion of the RACH message are transmitted in accordance with a same timing advance.

13. The UE of claim 1, wherein the RACH message comprises one or more demodulation reference signals, and the one or more processors are individually or collectively further operable to execute the code to cause the UE to:
transmit, via a third port of the plurality of ports, one or more other reference signals based at least in part on the multi-port RACH transmissions being enabled.

14. The UE of claim 13, wherein the one or more demodulation reference signals and the one or more other reference signals are transmitted via a same set of frequency resources.

15. A network entity, comprising:
one or more memories storing processor-executable code; and
one or more processors coupled with the one or more memories and individually or collectively operable to execute the code to cause the network entity to:
communicate, with a user equipment (UE), one or more signals that enable multi-port random access channel (RACH) transmissions; and
receive, from the UE, a RACH message based at least in part on multi-port RACH transmissions being enabled, wherein the RACH message indicates a plurality of sequences, and wherein, to receive the RACH message, the one or more processors are individually or collectively operable to execute the code to cause the network entity to:
receive a first portion of the RACH message indicative of a first subset of the plurality of sequences; and
receive a second portion of the RACH message indicative of a second subset of the plurality of sequences.

16. The network entity of claim 15, wherein the RACH message is received in accordance with a timing advance compensation based at least in part on the first portion of the RACH message and the second portion of the RACH message being received during a same RACH occasion.

17. The network entity of claim 15, wherein the RACH message is received during a multi-port RACH occasion comprising a plurality of single-port RACH occasions, and wherein, to receive the RACH message, the one or more processors are individually or collectively operable to execute the code to cause the network entity to:
receive the first portion of the RACH message during a first single-port RACH occasion of the plurality of single-port RACH occasions; and
receive the second portion of the RACH message during a second single-port RACH occasion of the plurality of single-port RACH occasions.

18. The network entity of claim 15, wherein the RACH message is received during a RACH occasion, and wherein, to receive the RACH message, the one or more processors are individually or collectively operable to execute the code to cause the network entity to:
receive the first portion of the RACH message during a first portion of the RACH occasion; and
receive the second portion of the RACH message during a second portion of the RACH occasion, wherein the second portion of the RACH message comprises a cyclic prefix subsequent to an end of the first portion of the RACH message based at least in part on the first portion of the RACH message and the second portion of the RACH message being transmitted during a same RACH occasion.

19. The network entity of claim 15, wherein, to communicate the one or more signals that enables the multi-port RACH transmissions, the one or more processors are individually or collectively operable to execute the code to cause the network entity to:
transmit a multi-port downlink signal, wherein enablement of the multi-port RACH transmissions is based at least in part on the multi-port downlink signal.

20. A method for wireless communications at a user equipment (UE), comprising:
communicating, with a network entity, one or more signals that enable multi-port random access channel (RACH) transmissions; and
transmitting, to the network entity, a RACH message via a plurality of ports of the UE based at least in part on multi-port RACH transmissions being enabled, wherein the RACH message indicates a plurality of sequences, and wherein transmitting the RACH message comprises:
transmitting, via a first port of the plurality of ports of the UE, a first portion of the RACH message indicative of a first subset of the plurality of sequences; and
transmitting, via a second port of the plurality of ports, a second portion of the RACH message indicative of a second subset of the plurality of sequences, wherein the first port is different from the second port.
